(19) United States
(12) Patent Application Publication
(10) Pub. No.: US 2015/0161524 A1
(43) Pub. Date: Jun. 11, 2015

(54) SAMPLING FROM A SET SPINS WITH CLAMPING

(71) Applicant: D-Wave Systems Inc., Burnaby (CA)

(72) Inventor: Firas Hamze, Vancouver (CA)

(21) Appl. No.: 14/561,086

(22) Filed: Dec. 4, 2014

Related U.S. Application Data
(60) Provisional application No. 61/912,385, filed on Dec. 5, 2013.

(51) Int. Cl. G06N 99/00; G06N 7/00

(52) U.S. Cl. CPC G06N 99/005; G06N 99/002; G06N 7/005

(57) ABSTRACT

The techniques and structures described herein generally relate to sampling from an available probability distribution to create a desirable probability distribution. This resultant distribution can be used for computing values used in computational techniques including: Importance Sampling and Markov chain Monte Carlo systems.

### BACKGROUND

1. Field

The present techniques generally relate to sampling from statistical distributions and using the samples.

2. Sampling

Sampling is a term used in different but related senses. In statistics, a sample is a plurality of data points collected from a statistical population. The process of sampling is preforming this collection by a defined procedure. In electrical engineering and related disciplines, sampling relates to collecting a plurality of measurements of an analog signal or some other physical system. Here the i^{th} sample of a variable X is denoted x⁽ⁱ⁾. In analog computing and simulations of physical systems, the foregoing meanings merge.

### Importance Sampling

Importance Sampling is a technique for estimating properties of a distribution of interest, by drawing samples from a different distribution, and weighting the samples as needed to recover the distribution of interest. When combined with the normalization constants of both distributions, the resulting estimator is unbiased. Alternatively one can normalize the estimator by the sum of the weights to yield an asymptotically unbiased estimator. Consider the expectation values of a function h(x) over a distribution of interest, π(x), also called the target distribution.

I≡∫h(x)π(x)dx (1)

In equation (1) we can replace the distribution of interest, π(x) with another distribution, the proposal distribution, provided the other distribution q(x) is strictly positive with respect to π(x). Now the integral is:

$$\int h ( x ) \frac{π ( x )}{q ( x )} q ( x ) d x \qquad ( 2 )$$

Further we define a factor called the importance weight, w(x)≡π(x)/q(x). The distributions may only be known to constant factors so a new weight can be defined \tilde{w}(x)≡\tilde{π}(x)/\tilde{q}(x) where tilde denotes the absence of normalization for the distributions. The integral in equation (2) can be approximated with a sum over samples from the distribution. Here an unbiased estimate is:

$$\hat{I} = \frac{{\sum }_{i = 1}^{N} h ( {X}^{( i )} ) \tilde{w} ( {X}^{( i )} )}{{\sum }_{i = 1}^{N} \tilde{w} ( {X}^{( i )} )} \qquad ( 3 )$$

A challenge in importance sampling is finding a good proposal distribution q(x). A poor choice of proposal will result in a large variance, that is, a very large number of samples must be drawn from the proposal before the weighted set is “representative” of the target distribution. As the number of dimensions in the distribution increases the problem becomes more pronounced.

### Markov Chain Monte Carlo

Markov Chain Monte Carlo is a class of computational techniques. A Markov chain may be used, for example when a probability distribution cannot be used. A Markov chain is a sequence of discrete random variables. When the chain is long enough the aggregate properties of the chain, for example, the mean, match the aggregate properties of a target distribution. This sequence is obtained by proposing a new point according to a Markovian proposal process. The new point is either rejected, in which case a new proposal is made, or accepted and the sequence moves on. The points which are accepted are those points that make for a probabilistic convergence to the target distribution. Further, the acceptance of a proposal can be done so that the Markov chain is reversible (also called having detailed balance). That is, product of transition rates over any closed loop of states in the chain must be the same in either direction. However, because of the technical nature of proposing and accepting proposals the new point often is local to the current point.

### Superconducting Qubits

There are many different hardware and software approaches under consideration for use in quantum computers. One hardware approach employs integrated circuits formed of superconducting material, such as aluminum and/or niobium, to define superconducting qubits. Superconducting qubits can be separated into several categories depending on the physical property used to encode information. For example, they may be separated into charge, flux and phase devices. Charge devices store and manipulate information in the charge states of the device; flux devices store and manipulate information in a variable related to the magnetic flux through some part of the device; and phase devices store and manipulate information in a variable related to the difference in superconducting phase between two regions of the phase device.

Many different forms of superconducting flux qubits have been implemented in the art, but all successful implementations generally include a superconducting loop (i.e., a “qubit loop”) that is interrupted by at least one Josephson junction. Some embodiments implement multiple Josephson junctions connected either in series or in parallel (i.e., a compound Josephson junction) and some embodiments implement multiple superconducting loops.

### Quantum Processor

A quantum processor may take the form of a superconducting quantum processor. A superconducting quantum processor may include a number of qubits and associated local bias devices, for instance two or more superconducting qubits. A superconducting quantum processor may also employ coupling devices (i.e., “couplers”) providing communicative coupling between qubits. Further detail and embodiments of exemplary quantum processors and associated systems that may be used in conjunction with the approaches set out herein are described in U.S. Pat. No. 7,533,068; U.S. Pat. No. 8,008,942; U.S. Pat. No. 8,195,596; U.S. Pat. No. 8,190,548; and U.S. Pat. No. 8,421,053.

### Adiabatic Quantum Computation

Adiabatic quantum computation typically involves evolving a system from a known initial Hamiltonian (the Hamiltonian being an operator whose eigenvalues are the allowed energies of the system) to a final Hamiltonian by gradually changing the Hamiltonian. A simple example of an adiabatic evolution is a linear interpolation between initial Hamiltonian and final Hamiltonian. An example is given by:

Hₑ=(1−s)Hᵢ+sH_{f} (4)

where Hᵢ is the initial Hamiltonian, H_{f} is the final Hamiltonian, Hₑ is the evolution or instantaneous Hamiltonian, and s is an evolution coefficient which controls the rate of evolution. As the system evolves, the s coefficient s goes from 0 to 1 such that at the beginning (i.e., s=0) the evolution Hamiltonian Hₑ is equal to the initial Hamiltonian Hᵢ and at the end (i.e., s=1) the evolution Hamiltonian Hₑ is equal to the final Hamiltonian H_{f}. Before the evolution begins, the system is typically initialized in a ground state of the initial Hamiltonian Hᵢ and the goal is to evolve the system in such a way that the system ends up in a ground state of the final Hamiltonian H_{f} at the end of the evolution. If the evolution is too fast, then the system can be excited to a higher energy state, such as the first excited state. In the present methods, systems and devices an “adiabatic” evolution is considered to be an evolution that satisfies the adiabatic condition:

\dot{s}| [symbol] 1|dHₑ/ds|0 [symbol] |=δg²(s) (5)

where \dot{s} is the time derivative of s, g(s) is the difference in energy between the ground state and first excited state of the system (also referred to herein as the “gap size”) as a function of s, and δ is a coefficient much less than 1. Generally the initial Hamiltonian Hᵢ and the final Hamiltonian H_{f} don't commute. That is, [Hᵢ, H_{f}]≠0.

The process of changing the Hamiltonian in adiabatic quantum computing may be referred to as evolution. The rate of change, for example change of s, is slow enough that the system is always in the instantaneous ground state of the evolution Hamiltonian during the evolution, and transitions at anti-crossings (i.e., when the gap size is smallest) are avoided. The example of a linear evolution schedule is given above. Other evolution schedules are possible including non-linear, parametric, and the like. Further details on adiabatic quantum computing systems, methods, and apparatus are described in, for example, U.S. Pat. No. 7,135,701 and U.S. Pat. No. 7,418,283.

### Quantum Annealing

Quantum annealing is a computation method that may be used to find a low-energy state, typically preferably the ground state, of a system. Somewhat similar in concept to classical annealing, the method relies on the underlying principle that natural systems tend towards lower energy states because lower energy states are more stable. However, while classical annealing uses classical thermal fluctuations to guide a system to its global energy minimum, quantum annealing may use quantum effects, such as quantum tunneling, to reach a global energy minimum more accurately and/or more quickly than classical annealing. It is known that the solution to a hard problem, such as a combinatorial optimization problem, may be encoded in the ground state of a system Hamiltonian (e.g., the Hamiltonian of an (sing spin glass) and therefore quantum annealing may be used to find the solution to such a hard problem. Adiabatic quantum computation may be considered a special case of quantum annealing for which the system, ideally, begins and remains in its ground state throughout an adiabatic evolution. Thus, those of skill in the art will appreciate that quantum annealing methods may generally be implemented on an adiabatic quantum computer. Throughout this specification and the appended claims, any reference to quantum annealing is intended to encompass adiabatic quantum computation unless the context requires otherwise.

Quantum annealing is an algorithm that uses quantum mechanics as a source of disorder during the annealing process. The optimization problem is encoded in a Hamiltonian H_{P}, and the algorithm introduces strong quantum fluctuations by adding a disordering Hamiltonian H_{D} that does not commute with H_{P}. An example case is:

H_{E}∝A(t)H_{D}+B(t)H_{P}, (6)

where A(t) and B(t) are time dependent envelope functions. For example, A(t) changes from a large value to substantially zero during the evolution and H_{E} may be thought of as an evolution Hamiltonian similar to Hₑ described in the context of adiabatic quantum computation above. The disorder is slowly removed by removing H_{D} (i.e., reducing A(t)). Thus, quantum annealing is similar to adiabatic quantum computation in that the system starts with an initial Hamiltonian and evolves through an evolution Hamiltonian to a final “problem” Hamiltonian H_{P} whose ground state encodes a solution to the problem. If the evolution is slow enough, the system will typically settle in the global minimum (i.e., the exact solution), or in a local minimum close in energy to the exact solution. The performance of the computation may be assessed via the residual energy (difference from exact solution using the objective function) versus evolution time. The computation time is the time required to generate a residual energy below some acceptable threshold value. In quantum annealing, H_{P} may encode an optimization problem and therefore H_{P} may be diagonal in the subspace of the qubits that encode the solution, but the system does not necessarily stay in the ground state at all times. The energy landscape of H_{P} may be crafted so that its global minimum is the answer to the problem to be solved, and low-lying local minima are good approximations.

The gradual reduction of disordering Hamiltonian H_{D} (i.e., reducing A(t)) in quantum annealing may follow a defined schedule known as an annealing schedule. Unlike adiabatic quantum computation where the system begins and remains in its ground state throughout the evolution, in quantum annealing the system may not remain in its ground state throughout the entire annealing schedule. As such, quantum annealing may be implemented as a heuristic technique, where low-energy states with energy near that of the ground state may provide approximate solutions to the problem. The removal of the disordering Hamiltonian H_{D} may occur after the same Hamiltonian has been added. That, is turn on the disordering Hamiltonian and then off.

### BRIEF SUMMARY

The techniques and structures described herein generally relate to sampling from an available probability distribution to create a desirable probability distribution. This resultant distribution can be used for computing values used in computational techniques including: Importance Sampling and Markov chain Monte Carlo systems.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a flow-diagram showing a method for creating a sample from a set of variables.

FIG. 2 is a flow-diagram showing a method for creating a sample from a set of variables.

FIG. 3 is a flow-diagram showing a method for making use of a sample to do Importance Sampling.

FIG. 4 is a flow-diagram showing a method for making use of a sample to implement Markov chain Monte Carlo techniques.

FIG. 5 is a flow-diagram showing a method for making a proposal for a Markov chain.

FIG. 6 is a flow-diagram showing a method computing a reverse probability.

FIG. 7 is a flow-diagram showing a method for accepting or rejecting a proposal for a Markov chain.

FIG. 8 is a block-diagram showing a technique for performing the above techniques on blocks of variables.

FIG. 9 is a block-diagram showing a technique for performing the above techniques on blocks of variables in a multiway recursion.

FIG. 10 is a schematic diagram of an exemplary hybrid computing system including a digital processor and quantum process that may be used to perform processing tasks described in the present disclosure.

### DETAILED DESCRIPTION

In the following description, some specific details are included to provide a thorough understanding of various disclosed embodiments. One skilled in the relevant art, however, will recognize that embodiments may be practiced without one or more of these specific details, or with other methods, components, materials, etc. In other instances, well-known structures associated with quantum processors, such as quantum devices, coupling devices, and control systems including microprocessors and drive circuitry have not been shown or described in detail to avoid unnecessarily obscuring descriptions of the embodiments of the present methods. Throughout this specification and the appended claims, the words “element” and “elements” are used to encompass, but are not limited to, all such structures, systems and devices associated with quantum processors, as well as their related programmable parameters.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment,” or “an embodiment,” or “another embodiment” means that a particular referent feature, structure, or characteristic described in connection with the embodiment is included in at least one embodiment. Thus, the appearances of the phrases “in one embodiment,” or “in an embodiment,” or “another embodiment” in various places throughout this specification are not necessarily all referring to the same embodiment. Furthermore, the particular features, structures, or characteristics may be combined in any suitable manner in one or more embodiments.

It should be noted that, as used in this specification and the appended claims, the singular forms “a,” “an,” and “the” include plural referents unless the content clearly dictates otherwise. Thus, for example, reference to a problem-solving system including “a quantum processor” includes a single quantum processor, or two or more quantum processors. It should also be noted that the term “or” is generally employed in its sense including “and/or” unless the content clearly dictates otherwise.

The headings provided herein are for convenience only and do not interpret the scope or meaning of the embodiments.

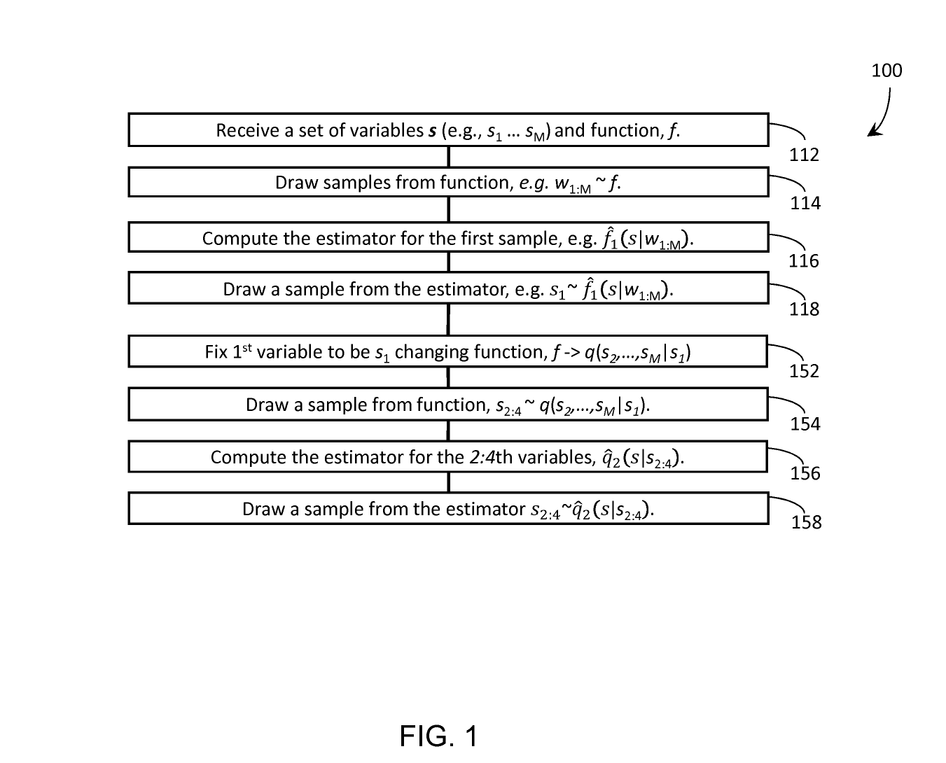

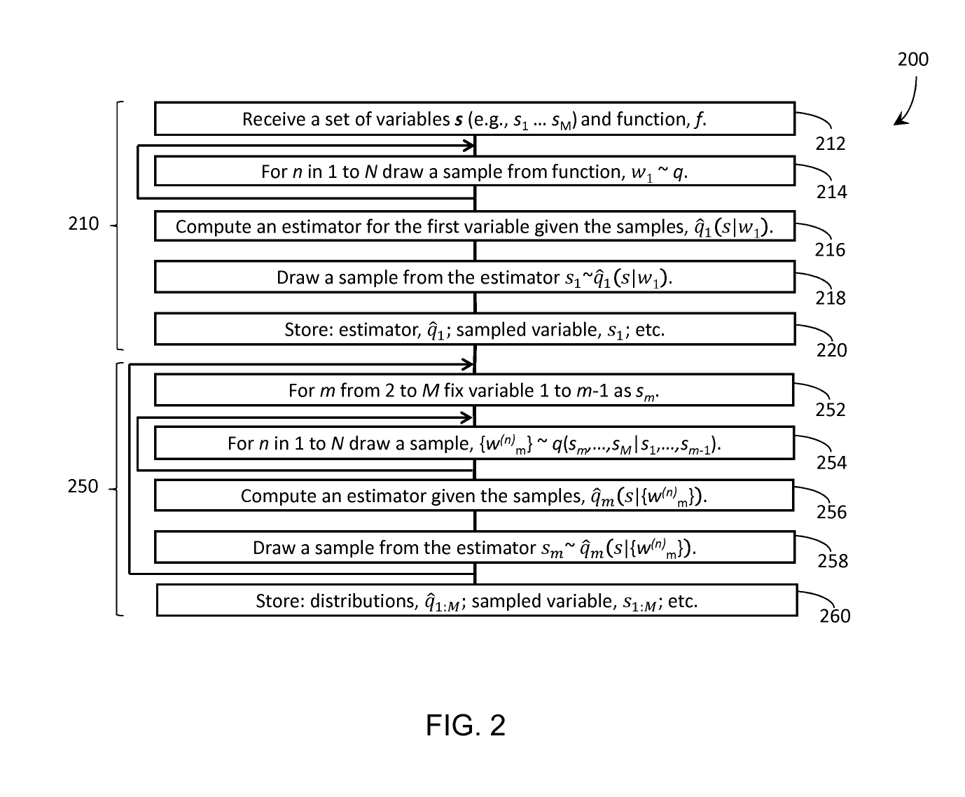

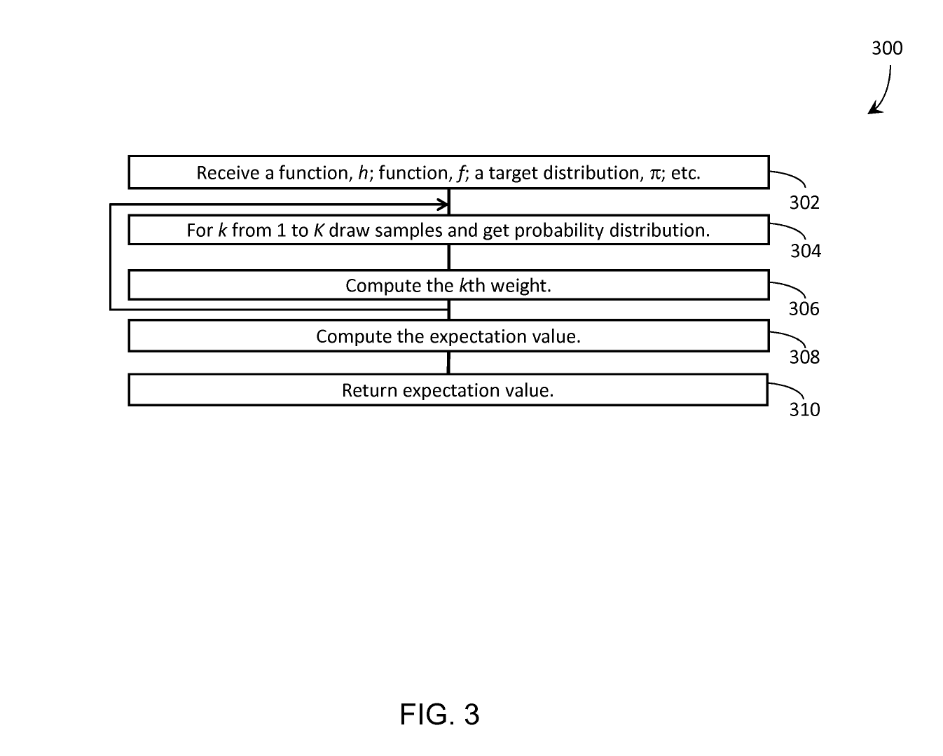

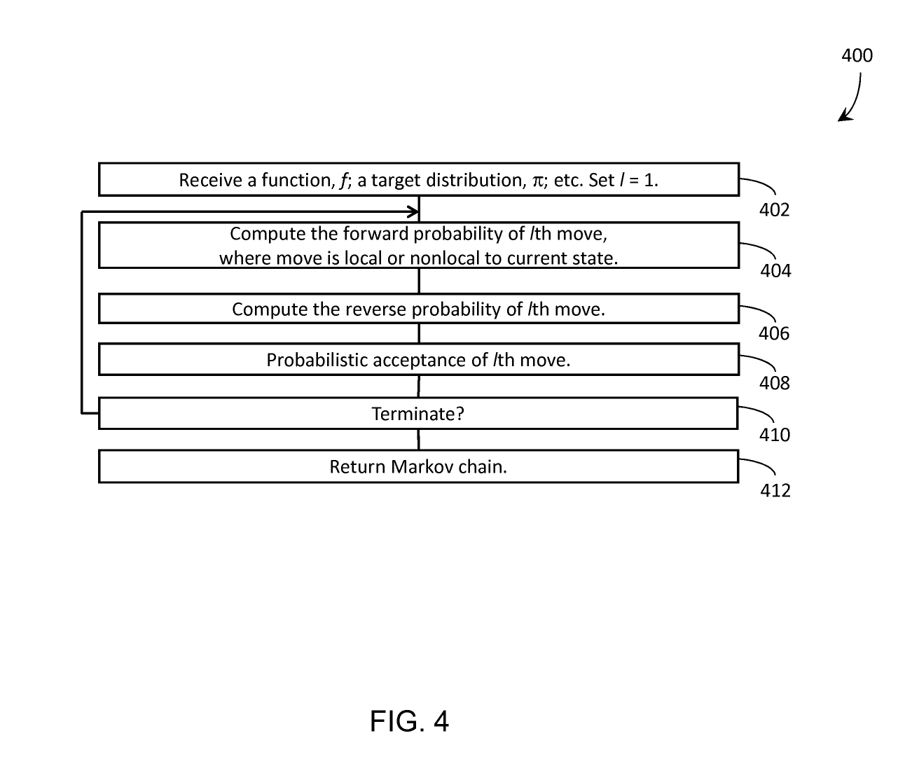

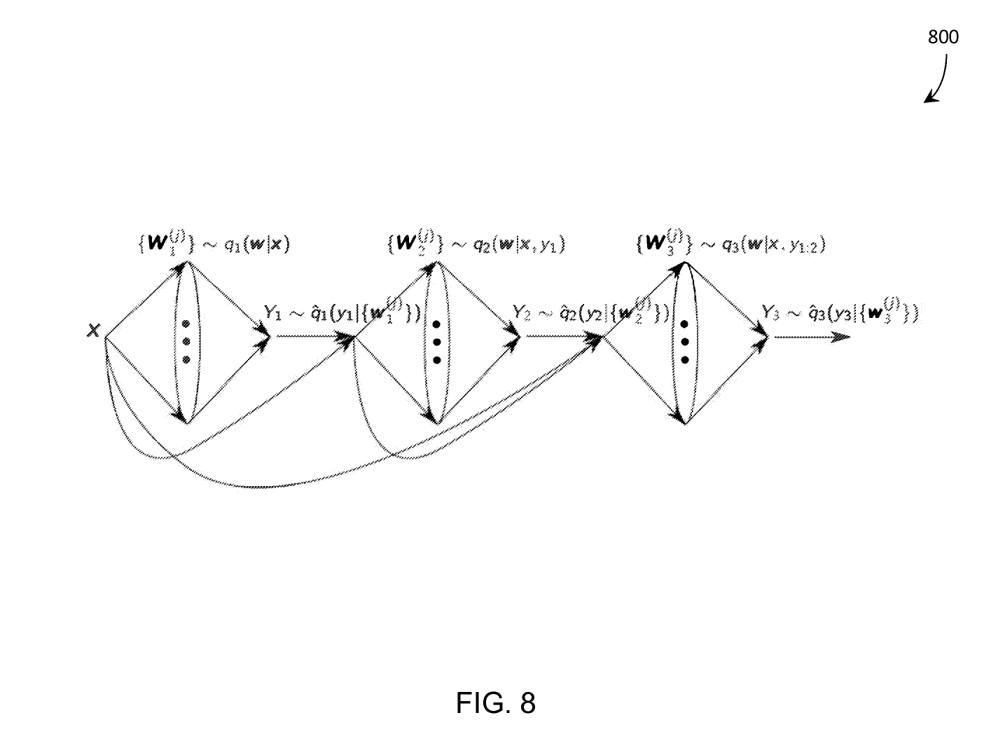

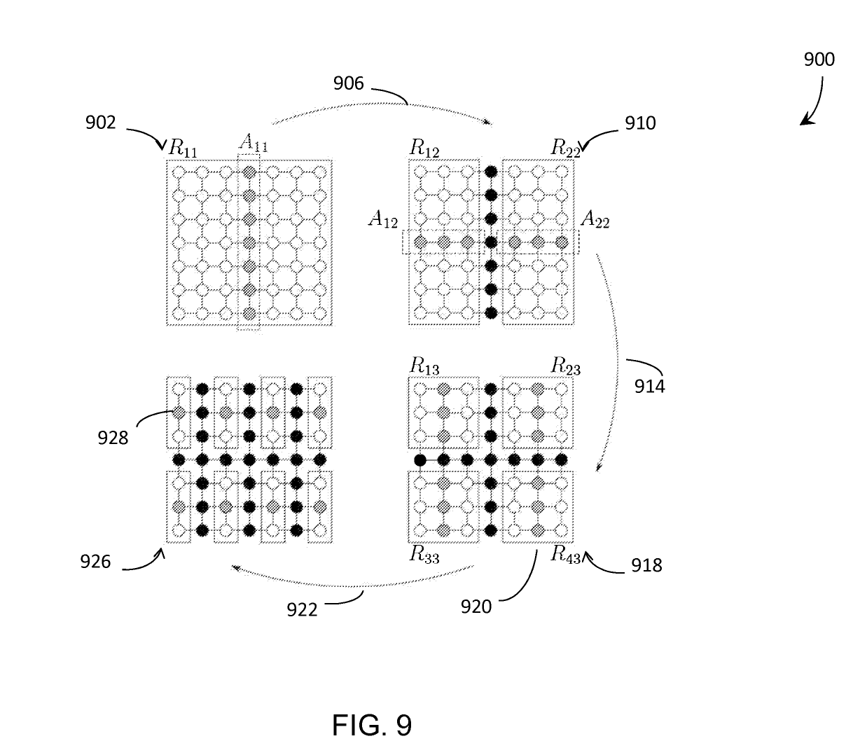

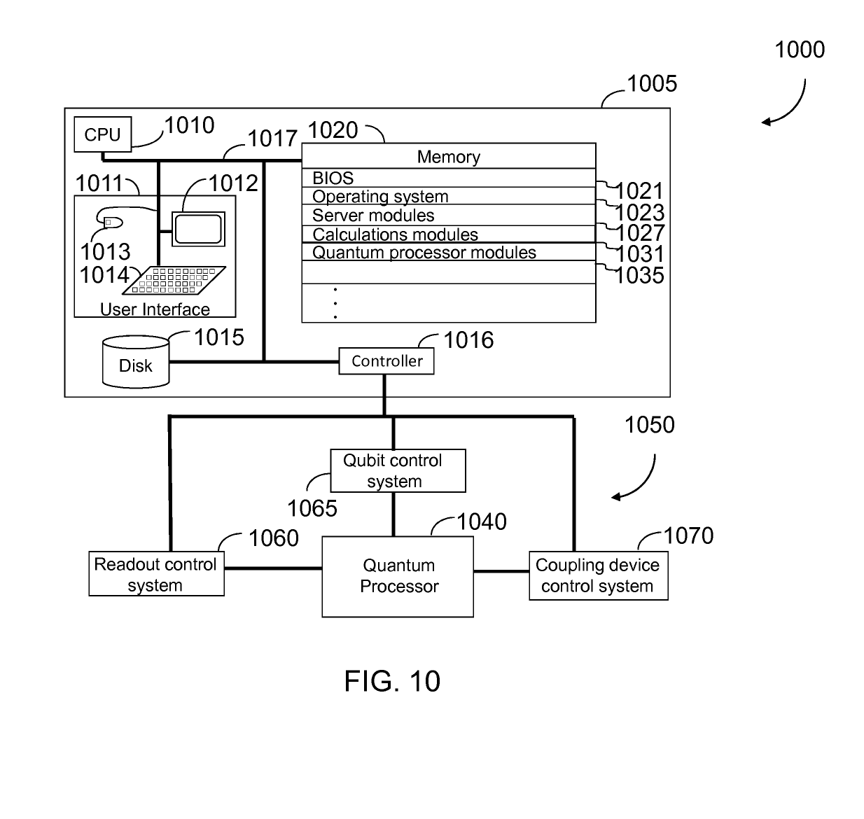

The present techniques relate to sampling from an available probability distribution and making use of the samples. Some concepts and notation are explained in the description for FIG. 1. Techniques for performing correct sampling from a proposal distribution are described in the description for FIG. 2. The correct sampling can provide useful insight for, or be used in, Importance Sampling (FIG. 3), Markov chain Monte Carlo techniques (FIGS. 4, 5, 6, and 7), and the like. The sampling techniques can be applied with blocks of variables (FIG. 8). Sampling can be performed on blocks of variables in a multiway recursion, for instance as illustrated in FIG. 9. Correct sampling can be performed via a digital computer on its own, or performed via a digital computer in cooperation with an analog computer, such as, a quantum computer. FIG. 10 shows a digital computer communicatively coupled to a quantum computer. Use of a quantum computer for sampling may advantageously allow samples to be taken from many disparate low energy states.

FIG. 1 is a flow-diagram showing a method 100 for creating a sample for a set of variables from a function for the purpose of illustrating various aspects of the embodiments. One or more of these acts may be performed by or via one or more circuits, for instance one or more processors (e.g., digital processors such as microprocessors, analog processor such as quantum processors).

At 112, a sampling device receives a set of variables s (e.g., s₁ . . . s_{M}) and a function f. In some embodiments, the variables represent spins (that is, sᵢ in {−1, +1}). In some embodiments, the variables are stored or processed in a digital computer. In some embodiments, the variables are stored or processed in an analog computer. The function, f, may be a function over a set of inputs including the set of M variables. An example of the function, f, is a function corresponding to a problem defined in an Ising spin glass. That is, the output of the function f corresponds to an energy value. Additional parameters can be included in the input to the function, such as, bias terms, coupling strengths, annealing time, and the like. Variation of some parameters may lead to a low energy state of an Ising spin glass associated with an instance of the function, f. Further, the problem can optionally be partition into sub-problems and/or parts of the problem can be fixed. The sub-problem or the problem with fixed variables is denoted function, q. Throughout, the function f and the function q may be interchanged.

At 114, a sample is drawn from the function. That is, a configuration of the variables, w, is received from the function f. The vector w is the same length as s and labeled w to avoid overloading the variable name in FIG. 1.

At 116, an estimator, \hat{f}₁, is computed. The estimator will be used to create information about the distribution associated with the function f. In one example, an estimator may count up the different values of a variable over the samples collected. This count can be normalized by the number of samples. In essence, the information in this estimator is a histogram. At 118, a sample is drawn from the estimator. A distribution of the first variable is made according to the information in the estimator. Then a sample is drawn from the distribution.

An example of fixing a variable is shown in method 100 at 152. A first variable s₁ is to be fixed. This changes the function, f->q(s₂, . . . , s_{M}|s₁). At 154, a computer draws a sample, including multiple variables, from the function, e.g., s_{2:4}˜q(s₂, . . . , s_{M}|s₁). Next at 156, an estimator is computed. This estimator is the second one in the method 100, but is for the block of variables (e.g., three variables, namely 2, 3, and 4 variables, \hat{q}₂(s|s_{2:4}). At 158, a sample is drawn from the estimator s_{2:4}˜\hat{q}₂(s|s_{2:4}).

FIG. 2 is a flow-diagram showing a 200 method for creating a sample from a set of variables and an associate function. Given a function a sample will be drawn from the function. The sample is used to compute a representative value of a variable and a probability distribution. The method 200 includes drawing samples of a first variable at block 210 and drawing samples over all remaining variables at block 250.

At 212, a computer or processor receives information specifying a set of M variables. In some embodiments, the variables represent spins (that is, sᵢ in {−1, +1}). In some embodiments, the variables are stored or processed in a digital computer or processor. In some embodiments, the computer is an analog computer or processor. Also received is a function, f, over a set of inputs including the set of M variables. An example of the function, f, is a function corresponding to a problem defined in an Ising spin glass. That is, the function f's output corresponds to an energy value. Additional parameters can be included in the input to the function, such as, bias terms, coupling strengths, annealing time, and the like. Variation of some parameters may lead to a low energy state of an Ising spin glass associated with an instance of the function, f.

In some embodiments the input to the function, f, is the set of M variables representing spins, and the parameters need to define the problem. These include a set of local qubit biases and inter qubit couplings (denoted as hᵢ and Jᵢⱼ). The input and output of the function can be represented as Sᵢ=f(hᵢ, Jᵢⱼ, . . . ) for all i in {1, 2, . . . M} and j>i. Additional parameters such as an annealing schedule can optionally be provided. The function f will be associated with a probability distribution.

At 214, a set of samples is drawn from the function. That is, for samples 1 through N index by i superscript get the output of function f. This may be denoted as w₁⁽ⁱ⁾˜f(s₁, . . . , s_{M}), where ˜ means sample from, the superscript denotes the same number, and the subscript denotes the qubit number. When the sample is being drawn from a quantum processor configured as a quantum annealer, the drawing of samples involves running the problem defined on the Ising spin glass per an annealing schedule, and reading out a result. In some embodiments, in block 110 the readout is of the first variable only.

At 216, an estimator is computed. The estimator will be used to create information on the distribution associated with the function f. One example of an estimator is to count up the different values of a variable over the samples collected. This can be normalized by the number of samples. In essence, the information in this estimator is a histogram. An example of an estimator is:

$${\hat{q}}_{1 m} ( {s}_{m} ) ≡ \frac{1}{N} {\sum }_{i = 1}^{N} {δ}_{{s}_{m}} ( {t}_{m}^{( i )} ) \qquad ( 7 )$$

where δᵢ is a delta function that is zero at all locations but index i where it is one. Here the index is over the spin states. The value of the estimator for the opposite spin value can be computed \hat{q}ₘ(−1)=1−\hat{q}ₘ(+1) because in a binary system the probabilities sum to one.

At 218, a sample is drawn from the estimator. A distribution of the first variable is made according to the information in the estimator. Then a sample is drawn from the distribution, s₁˜\hat{q}₁(s). An example of performing this is generating a random number between 0 and 1. If the random number is less than \hat{q}₁(+1) assign s₁ to +1, else assign to −1.

At 220, the estimator and associated information is saved. Also saved is the sample, s₁. Processing continues in block 250.

In block 250, there are two loops. There is an outer loop over the variables from variable 2 to variable M. There is an inner loop to draw samples from a clamped version of function, f. The clamped version of the function, f has one or more fixed variables as input.

The outer loop begins at 252. For variables 2 to M as indexed by m, variables are fixed in states determined in previous iterations. The initial fixed value for 252 is determined in block 110. In repeating returns to 252, the index m is incremented by one.

The inner loop begins at 254. A series of samples are drawn each from function, f, but with one or more variables fixed. This fixing of variables is called clamping. The ith sample of the mth variable drawn from a function with clamping is denoted by sₘ⁽ⁱ⁾=f(s₁, . . . , sₘ₋₁, Sₘ, . . . , S_{M}) where s denotes a fixed variable and S denotes an unfixed variable.

In an analog computer the fixing of a variable involves tuning the computer to enforce a value on the variable. For example, with a quantum computer the fixing of a variable involves applying a signal associated with the diagonal single qubit term of sufficient strength to fix the qubit's state. In a quantum processor including rf SQUID qubit, the fixing of a variable involves applying a strong magnetic field to the qubit. For example, the magnetic field can be associated with single qubit bias.

In some embodiments the non-fixed values are read out and stored. In some embodiments if the fixed value is not in the fixed state an exception is recorded. Exceptions can be used to repeat the sampling.

At 256, an estimator is computed. The estimator will be used to create information on the distribution associated with the function f, with clamping.

At 258, a sample is drawn from the estimator. That is a simulation is made of the distribution of the first variable according to the information in the estimator. Then a sample is made, sₘ˜\hat{q}ₘ(s). Unless the index has reached its end, the last variable, processing continues in block 252.

If the “for loop” is complete, at 260, the estimator and associated information is saved. Also saved are the samples, S_{1:M}.

The description of the method found in FIG. 2 may be refactored into a single outer and inner loop. The drawing of an initial sample in block 110 is thus one more iteration through the outer loop in block 250 with some additional acts, steps or branching logic.

FIG. 3 is a flow-diagram showing a method 300 for making use of a set of samples to do Importance Sampling. At 302, the computer receives a function, h; a function, f, associated with an associated proposal distribution, a target distribution, π; and the like. A loop starts at 304. For the variable k from 1 to K a set of samples is drawn. In some embodiments, the samples are drawn according to method 200. The loop portion 304 yields values for the samples {yₘ^{(k)}} (or y^{(k)}) and a probability distribution \hat{q}ₘ(yₘ^{(k)}). At 306, the weights for the Importance Sampling are created. The weight may be expressed as:

$$w ( {y}^{( k )} ) = \frac{π ( {y}^{( k )} )}{{\prod }_{m = 1}^{M} {\hat{q}}_{m} ( {y}_{m}^{( k )} )} \qquad ( 8 )$$

where the index mth refers to the mth version of the estimator and mth variable. In some embodiments there is one estimator for many variables. A weight is made for each sample. At 308 the expectation value of the supplied function h is computed. Examples of the function h include average, variance, higher moments, custom functions, and the like.

$${E}_{π} [ h ( y ) ] = \frac{1}{K} {\sum }_{k} w ( {y}^{( k )} ) h ( {y}^{( k )} ) \qquad ( 9 )$$

At 310 the computer returns the expectation value.

Some embodiments make use of conditional independence. An unknown proposal distribution, f, factorized into its univariate conditionals:

f(y|x)=f₁(y₁|x)f₂(y₂|x,y₁) . . . fₘ(yₘ|x,y_{1:m-1}) (10)

The factoring into conditionals can be used to break a sampling problem into sub-problems. Accounting for conditionals in hardware involves considering the effect of the fixed portions of a configuration on a non-fixed portion. For example, if variables y₁ and y₁₀₀ are uncoupled nothing is to be done. If variable y₁ and y₂ are coupled, then if y₁ is fixed the effect on y₂ is to account for this by adjusting the local bias on y₂.

FIG. 4 is a flow-diagram showing a method 400 for making use of samples to implement Markov chain Monte Carlo techniques. A chain generator follows the method 400 to propose a new configuration as a new point in the chain. The new point is tested and accepted per Markov chain Monte Carlo techniques. Using a quantum annealing to provide samples allows the proposals from disparate states including low energy states.

At 402, a Markov chain generator receives a distribution π, a function f, a set of variables, and the like. A counter is set to one, e.g. I=1. At 404, given a current point x, a new point, y, in the Markov Chain is proposed according to a Markovian proposal process using samples draft from the function f. In normal Markov chain construction certain technical requirements must be met. These have the unfortunate consequence that the proposal is for local states to the current state. That is, the proposals may differ by a bit flip, a few bit flips, and the like. Using a quantum annealer with and without fixed variables allows for proposals to be drawn from many disparate configurations that are local or non-local. In addition, states with low energy can be proposed.

At 406, a Markov chain generator calculates the probability of the reverse transition from the proposal to the current state. Again the current state is a configuration of variables. The proposal is a new state that is a configuration as suggested by a sampling process like in methods 200. At 406, a check is made to ensure that the transition from the current state to the new state is reversible (also called making sure the chain has detailed balance). That is, the product of transition rates over any closed loop of states in the chain must be the same in either direction.

To calculate the reverse probability the chain generator takes the proposed state and fixes the variables in the function f accordingly. A sample is made and an estimator generated according to method 200.

At 408, the proposal y is accepted and added to the chain with a probability α. The value of the value of the probability α is the minimum 1 and value:

$$\frac{π ( y ) {\prod }_{m = 1}^{M} {\hat{q}}_{m} ( {x}_{m} )}{π ( x ) {\prod }_{m = 1}^{M} {\hat{q}}_{m} ( {y}_{m} )} \qquad ( 11 )$$

Again x is the current point in the chain, the target distribution is π, and \hat{q}ₘ are the estimators. The set of estimators \hat{q}ₘ(yₘ) are associated the forward probability of the proposal and set of estimators \hat{q}ₘ(xₘ) is created in evaluating the reverse probability. Termination is tested at 410. The results, including the chain are returned at 412.

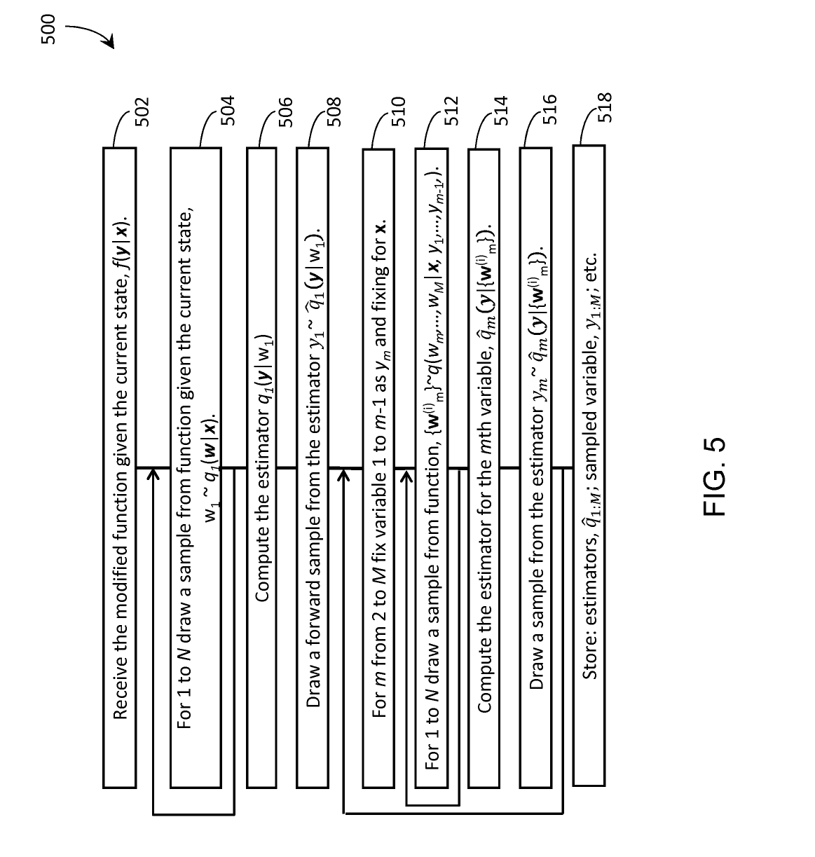

FIG. 5 is a flow-diagram showing a method for making a proposal for a Markov chain. At 502, the chain generator receives the modified function given the current state, f(y|x). At 504 the function f, now modified to reflect the current state x and called q, is sampled N times for the first variable in a process like in 210. That is, {w⁽ⁿ⁾₁}˜q₁(w|x), where w is the sample variables. The N samples are drawn in a “for loop” or similar iterative structure. At 506, an estimator for the first variable is constructed, \hat{q}₁(y|{w₁⁽ⁿ⁾}), for example using techniquez from method 100. At 508 a forward sample for the first variable is drawn from the first estimator y₁˜\hat{q}₁(y|{w₁⁽ⁿ⁾}).

At 510, the chain generator enters an outer “for loop” in index m from 2 to M (the number of variables). An inner loop starts at 512. The function q is sampled N with the first to m−1 variables fixed, like in process 250 (FIG. 2). That is, {w⁽ⁿ⁾ₘ}˜qₘ(wₘ . . . w_{M}|x, y₁ . . . yₘ₋₁), where wₘ . . . w_{M} are the sampled variables, x the current state and can include biases on qubits. The N samples are drawn in a “for loop” or similar iterative structure. At 514, an estimator for the first variable is constructed, \hat{q}₁(y|{w₁⁽ⁿ⁾}), for example using technique from method 100. At 516, a forward sample for the present variable is drawn from the current estimator yₘ˜\hat{q}ₘ(y|{wₘ⁽ⁱ⁾}). At 518, the sampled variables and created estimators are stored.

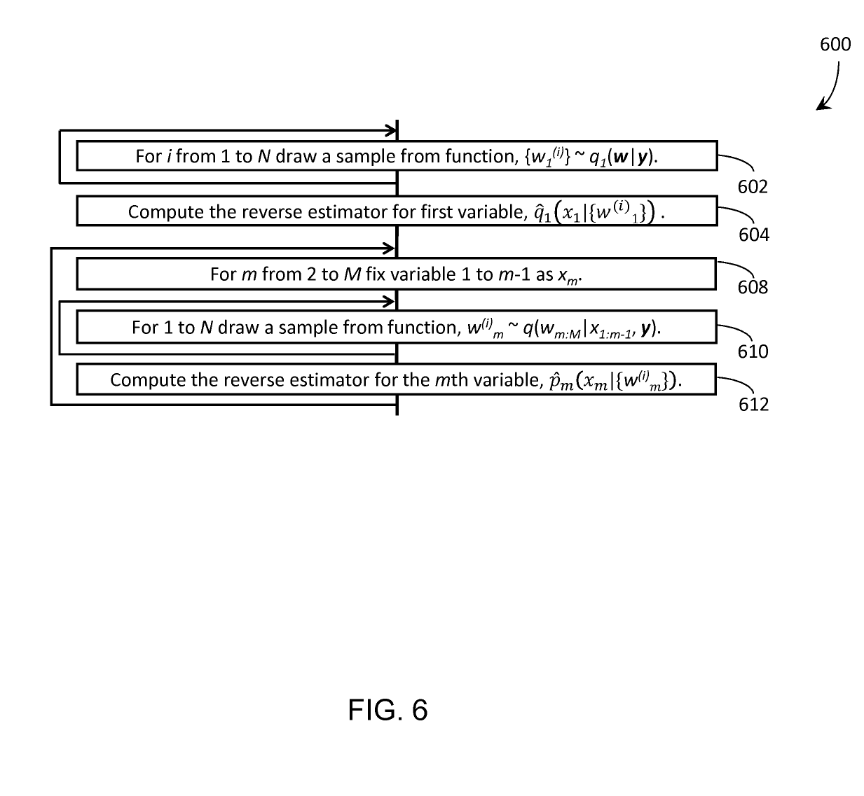

FIG. 6 is a flow-diagram showing a method 600 of computing a reverse probability for creating a Markov chain. In process 600 the computation of the reverse probability has a similar form to method 500, but without sampling from the estimators.

At 602, a loop begins iterating i from 1 to N, drawing a sample from a function, {w₁⁽ⁱ⁾}˜q₁(w|y). That is, create a sample of size N from the function given the proposal y. At 604, the Markov chain generator computes the reverse estimator for a first variable in the set of variable, \hat{q}₁(x₁|{w⁽ⁱ⁾1}). At 608, an outer iterative loop begin over m from 2 to M fix variables 1 to m−1 as xₘ and given the proposal y. That is, fix the variables with values from the current state. Within the outer loop is an inner loop. At 610, in the inner loop the generator draws N samples from the function, w⁽ⁱ⁾ₘ˜q(w_{m:M}|x_{1:m-1}, y). At 612, within the outer loop the samples are used to compute the reverse estimator for the mth variable, \hat{q}ₘ(xₘ|{wₘ⁽ⁱ⁾}).

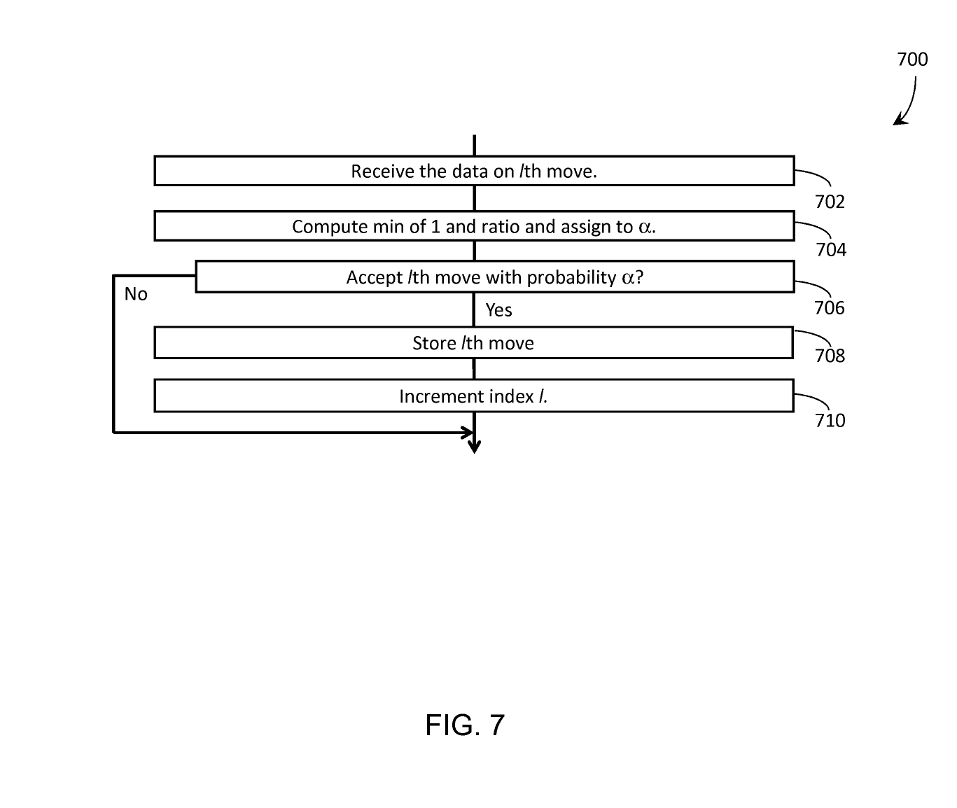

FIG. 7 is a flow-diagram showing a method 700 for accepting or rejecting a proposal for a Markov chain. The Markov chain generator receives the data on the Ith move. That is the current state, x, the proposed state, y, and associated probabilities, estimators, and the like. At 710, the minimum of 1 and Equation (11) is computed and assigned to probability α. At 706, the jth move is accepted with probability α. If the move is accepted, at 708, the Markov chain is updated and, at 710, the index is incremented. If the move is not accepted, control returns to 404 in method 400 (FIG. 4).

FIG. 8 is a diagram showing a technique 800 for performing the above techniques on blocks of variables. In particular, there are a series of samplings and estimators computed. Each sampling can be for a variable, for instance as described in method 200, or for a block of variables. As such, the index m can refer to the mth estimator or the estimator for the mth variable depending on the context.

FIG. 9 is a block-diagram showing a process 900 for performing the above techniques on blocks of variables in a multiway recursion. Shown is an example of how to exploiting conditional independence to accelerate sampling on a grid of qubits or groups of qubits.

In particular, FIG. 9 illustrates the process 900 as being applied to four instances of a seven by seven grid of groups of qubits with inter-group couplings. Initially the grid 902, includes samples that are sequentially drawn from the vertical shaded column called A₁₁. The two sets of variables separated by the column are labeled R₁₂, and R₂₂. Once the variables in A₁₁ are sampled, the variables in R₁₂ and R₂₂ are independent dividing the grid into two independent sets as shown by transition 906. In 910, sampling within the sets R₁₂, and R₂₂ continues. By sampling simultaneously along the horizontal bisectors, A₁₂, and A₂₂, a grid is transformed (914) to a grid 918 partitioned 4 ways. The bisection continues with sets R₁₃, R₂₃, R₃₃, and R₄₃ divided (e.g., by bisector 920) along transition 922 to create grid 926. The sets within grid 926 can be further bisected and bisector 928 is an example. In process 900, the number of calls to the sampling process is advantageously reduced from order L² to order L log₂ L, where L is the length of the grid.

FIG. 10 illustrates computing system 1000 including a digital computer 1005 coupled to a quantum computer 1050. Shown is an exemplary digital computer 105 including a digital processor that may be used to perform classical digital processing tasks described in the present systems and methods. Those skilled in the relevant art will appreciate that the present systems and methods can be practiced with other digital computer configurations, including hand-held devices, multiprocessor systems, microprocessor-based or programmable consumer electronics, personal computers (“PCs”), network PCs, mini-computers, mainframe computers, and the like. Digital computer 105 will at times be referred to in the singular herein, but this is not intended to limit the application to a single digital computer. The present systems and methods can also be practiced in distributed computing environments, where tasks or modules are performed by remote processing devices, which are linked through a communications network. In a distributed computing environment, program modules may be located in both local and remote memory storage devices.

Digital computer 1005 may include at least one processing unit (such as, central processor unit 1010), at least one system memory 1020, and at least one system bus 1017 that couples various system components, including system memory 1020 to central processor unit 1010.

The digital processor may be any logic processing unit, such as one or more central processing units (“CPUs”), digital signal processors (“DSPs”), application-specific integrated circuits (“ASICs”), etc. Unless described otherwise, the construction and operation of the various blocks shown in FIG. 1 are of conventional design. As a result, such blocks need not be described in further detail herein, as they will be understood by those skilled in the relevant art.

System bus 1017 can employ any known bus structures or architectures, including a memory bus with a memory controller, a peripheral bus, and a local bus. System memory 1020 may include non-volatile memory such as read-only memory (“ROM”) and volatile memory such as random access memory (“RAM”) (not shown). An basic input/output system (“BIOS”) 1021, which can form part of the ROM, contains basic routines that help transfer information between elements within digital computer 1005, such as during startup.

Digital computer 1005 may also include other non-volatile memory 1015. Non-volatile memory 1015 may take a variety of forms, including: a hard disk drive for reading from and writing to a hard disk, an optical disk drive for reading from and writing to removable optical disks, and/or a magnetic disk drive for reading from and writing to magnetic disks. The optical disk can be a CD-ROM or DVD, while the magnetic disk can be a magnetic floppy disk or diskette. Non-volatile memory 1015 may communicate with digital processor via system bus 1017 and may include appropriate interfaces or controllers 1016 coupled to system bus 1017. Non-volatile memory 1015 may serve as long-term storage for computer-readable instructions, data structures, program modules and other data for digital computer 1005. Although digital computer 1005 has been described as employing hard disks, optical disks and/or magnetic disks, those skilled in the relevant art will appreciate that other types of non-volatile computer-readable media may be employed, such a magnetic cassettes, flash memory cards, Bernoulli cartridges, Flash, ROMs, smart cards, etc.

Various program modules, application programs and/or data can be stored in system memory 1020. For example, system memory 1020 may store an operating system 1023, and server modules 1027. In some embodiments, server module 1027 includes instruction for communicating with remote clients and scheduling use of resources including resources on the digital computer 1005 and quantum computer 1050. For example, a Web server application and/or Web client or browser application for permitting digital computer 1005 to exchange data with sources via the Internet, corporate Intranets, or other networks, as well as with other server applications executing on server computers.

In some embodiments system memory 1020 may store a calculation module 1031 to perform pre-processing, co-processing, and post-processing to quantum computer 1050. In some embodiments, calculation module 1031 is used to handle samples from a quantum computer per methods 200, 300, 400, 500, and 600. In accordance with the present systems and methods, system memory 1020 may store at set of quantum computer interface modules 1035 operable to interact with a quantum computer 1050. While shown in FIG. 10 as being stored in system memory 1020, the modules shown and other data can also be stored elsewhere including in nonvolatile memory 1015.

The quantum computer 1050, an example of an analog computer, is provided in an isolated environment (not shown) to shield the internal elements of the quantum computer from heat, magnetic field, and the like. The quantum computer includes a quantum processor 1040 including qubits having programmable topology as discussed herein. The qubits are readout via readout out system 1060. These results are fed to the various modules in the digital computer 1005 including server modules 1027, calculation module 1031, or quantum computer interface modules 1035, stored in nonvolatile memory 1015, returned over a network or the like. The qubits are controlled via qubit control system 1065. The couplers are controlled via coupler control system 1070. In some embodiments of the qubit control system 1065 and the coupler control system 1070 are used to implement quantum annealing as described herein on quantum processor 1040. The quantum processor 1040 is an example of an analog processor.

In some embodiments the digital computer 1005 can operate in a networking environment using logical connections to at least one client computer system. In some embodiments the digital computer 1005 is coupled via logical connections to at least one database system. These logical connections may be formed using any means of digital communication, for example, through a network, such as a local area network (“LAN”) or a wide area network (“WAN”) including, for example, the Internet. The networking environment may include wired or wireless enterprise-wide computer networks, intranets, extranets, and/or the Internet. Other embodiments may include other types of communication networks such as telecommunications networks, cellular networks, paging networks, and other mobile networks. The information sent or received via the logical connections may or may not be encrypted. When used in a LAN networking environment, digital computer 101 may be connected to the LAN through an adapter or network interface card (“NIC”) (communicatively linked to bus 1017). When used in a WAN networking environment, digital computer 1005 may include an interface and modem (not shown), or a device such as NIC, for establishing communications over the WAN. Non-networked communications may additionally, or alternatively be employed.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other methods of quantum computation, not necessarily the exemplary methods for quantum computation generally described above.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including U.S. provisional application Ser. No. 61/912,385 filed Dec. 5, 2013, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A non-transitory computer-readable storage medium containing processor-executable instructions, which when executed cause at least one processor to:
draw a first sample for a plurality of variables from a function defined on an analog processor;
compute a first estimator for the first sample;
draw a second sample from the first estimator, the second sample including a value for a first variable in the plurality of variables;
fix the first variable in the plurality of variables to the value for the first variable in the plurality of variables to define an unfixed subset of the plurality of variables, and an updated version of the function defined on an analog processor;
draw a third sample for the unfixed subset of the plurality of variables from the updated version of the function defined on an analog processor;
compute a second estimator for the third sample; and
draw a fourth sample from the second estimator.

2. A non-transitory computer-readable storage medium containing processor-executable instructions, which when executed cause at least one processor to:
draw a first plurality of samples for a plurality of variables from a function defined on an analog processor;
compute a first estimator for the first plurality of samples;
draw a second sample from the first estimator, the second sample including a value for the first variable in the plurality of variables;
for the function, during a first iteration on the function:
fix an instant first variable in the plurality of variables to value for the first variable in the plurality of variables, wherein fixing the instant first variable defines: an instant fixed subset of plurality of variables, an instant unfixed subset of plurality of variables, and an instant partially fixed version of the function;
draw an instant plurality of samples for the instant unfixed subset of the plurality of variables from the instant partially fixed version of the function defined on the analog processor;
compute an instant estimator for the instant unfixed subset of the plurality of variables from the instant plurality of samples; and
draw an instant value for an instant second variable of the unfixed subset of plurality of variables from the instant estimator.

3. The computer-readable storage medium of claim 2 wherein the processor-executable instructions when executed further cause the at least one processor to:
store the value for the first variable in the plurality of variables.

4. The computer-readable storage medium of claim 2 wherein the processor-executable instructions when executed further cause the at least one processor to:
for the function, during a first iteration on the function:
store the instant value for the instant second variable of the unfixed subset of plurality of variables from the instant estimator.
